(19) United States
(12) Patent Application Publication
(10) Pub. No.: US 2025/0390886 A1
(43) Pub. Date: Dec. 25, 2025

(54) STAND-IN SYSTEM AND TRANSACTION CATEGORY CODE (TCC) RECOMMENDATION FEATURE

(71) Applicant: MASTERCARD INTERNATIONAL INCORPORATED, Purchase, NY (US)

(72) Inventors: Bhavy Gandhi, Banswara (IN); Anukriti Singh, Kota (IN); Sanchit Kaushik, Pune (IN)

(21) Appl. No.: 19/206,847

(22) Filed: May 13, 2025

Related U.S. Application Data
(60) Provisional application No. 63/662,673, filed on Jun. 21, 2024.

(51) Int. Cl. G06Q 20/40

(52) U.S. Cl. CPC G06Q 20/405; G06Q 20/4016

(57) ABSTRACT

Systems and methods for generating a transaction approval limit that is based on transaction data and fraud rate with respect to transaction criteria to optimize for increased transaction approval and minimization of fraud rate.

### BACKGROUND

Payment transactions over a payment network involve communications between numerous systems including merchant systems, acquirer systems, payment network systems, and issuer systems. When an issuer is unavailable, for example, due to connectivity issues, stand-in systems on the payment network can be used to approve or deny transactions on behalf of the issuer. Stand-in systems typically use a set of default approval limits for determining whether or not to approve or deny a transaction.

### BRIEF SUMMARY

Systems and methods for generating a transaction approval limit that is based on transaction data and fraud rate with respect to transaction criteria to optimize for increased transaction approval and minimization of fraud rate are described.

In some aspects, the techniques described herein relate to a method, including: receiving, at a stand-in system with a transaction category code (TCC) recommendation feature on a payment network, a first request to approve or deny a first transaction, wherein the first transaction includes a transaction amount; determining, at the stand-in system, a current transaction approval limit for the first transaction based on an optimization for increased transaction approval and minimization of fraud; determining, at the stand-in system, in view of the current transaction approval limit, that the transaction amount is above the current transaction approval limit; in response to determining that the transaction amount is above the current transaction approval limit, denying the first transaction; obtaining, by the stand-in system, an updated transaction approval limit from the TCC recommendation feature, wherein the TCC recommendation feature adjusts the current transaction approval limit based on transaction data and fraud rate with respect to transaction criteria, wherein the updated transaction approval limit is generated to optimize for the increased transaction approval and minimization of fraud rate; receiving, at the stand-in system, a second request to approve or deny a second transaction, wherein the second transaction is for a same transaction amount as the first transaction; determining, at the stand-in system, that the same transaction amount is at or below the received updated transaction approval limit; and in response to determining that the transaction amount is at or below the received updated transaction approval limit, approving the second transaction.

In some aspects, the techniques described herein relate to a computer-readable storage medium having instructions stored thereon for transaction category code (TCC) recommendation feature that when executed by a computing system direct the computing system to: generate a transaction approval limit that is based on transaction data and fraud rate with respect to transaction criteria to optimize for increased transaction approval and minimization of fraud rate by: extracting a plurality of transaction data for a time period, wherein the plurality of transaction data includes data belonging to a particular account range and satisfying a set of criteria; calculating overall fraud rate (F) and total transaction amount (T); assigning the plurality of transaction data to appropriate buckets grouped according to transaction amounts; calculating, for each bucket, approval limit calculation data, wherein approval limit calculation data includes a transaction count, a transaction amount, an approval count, an approval amount, a fraud count, a fraud amount, an overall transaction amount, a transaction percentage, a cumulative approval amount, a cumulative fraud amount, and a fraud rate; applying a set of filter conditions on the approval limit calculation data, wherein the set of filter conditions includes a filter selecting for a determined first bucket that is above a current transaction approval limit; and selecting the transaction approval limit based on the applied set of filter conditions.

In some aspects, the techniques described herein relate to a payment network, including: a system, wherein the system includes: a first processing system; one or more first storage media; and first instructions stored on the one or more first storage media that, when executed by the first processing system, direct the system to: receive a preauthorization request for a transaction; determine that an issuer is unavailable; and based on the determination that the issuer is unavailable, direct a first request to approve or deny the transaction in place of the preauthorization request to a stand-in system; and a stand-in system, wherein the stand-in system includes: a second processing system; one or more second storage media; and second instructions stored on the one or more second storage media that, when executed by the second processing system, direct the stand-in system to: receive the first request to approve or deny the transaction; and determine an approval or denial of the transaction based on a transaction approval limit that is based on transaction data and fraud rate with respect to transaction criteria to optimize for increased transaction approval and minimization of fraud rate, wherein the stand-in system includes a transaction category code (TCC) recommendation feature that adjusts the transaction approval limit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an example conventional payment card process.

FIG. 1B illustrates an example payment card process with an authorization stand-in system.

FIG. 2A illustrates an example operating environment for a TCC recommendation feature associated with a stand-in system on a payment network.

FIG. 2B illustrates an example method at a stand-in system with a transaction category code (TCC) recommendation feature.

FIG. 3A illustrates an example method of generating a transaction approval limit.

FIGS. 3B-3F provide an illustrative example of the method of generating a transaction approval limit of FIG. 3A.

### DETAILED DESCRIPTION

Systems and methods for generating a transaction approval limit that is based on transaction data and fraud rate with respect to transaction criteria to optimize for increased transaction approval and minimization of fraud rate are described.

Typically, an issuer sets or accepts a default limit for a stand-in system to use as an approval limit. However, there is a fraud risk that comes with approving or denying a transaction based on limited information (e.g., transaction amount). Indeed, because stand-in systems have less visibility into factors considered by the issuer (e.g., customer information, account balance, etc.), using a stand-in system can lead to higher fraud rates. Some stand-in systems may try to lower fraud rates by setting low default approval limits. However, doing so often leads to undesirable transaction approval rates, while not necessarily decreasing fraud rates. Advantageously, through the methods described herein, it is possible to maintain or reduce fraud rates while providing customized approval limits for issuers. In this manner, it is possible to provide limits that change over time so as to maintain or reduce fraud and optimize transaction approvals.

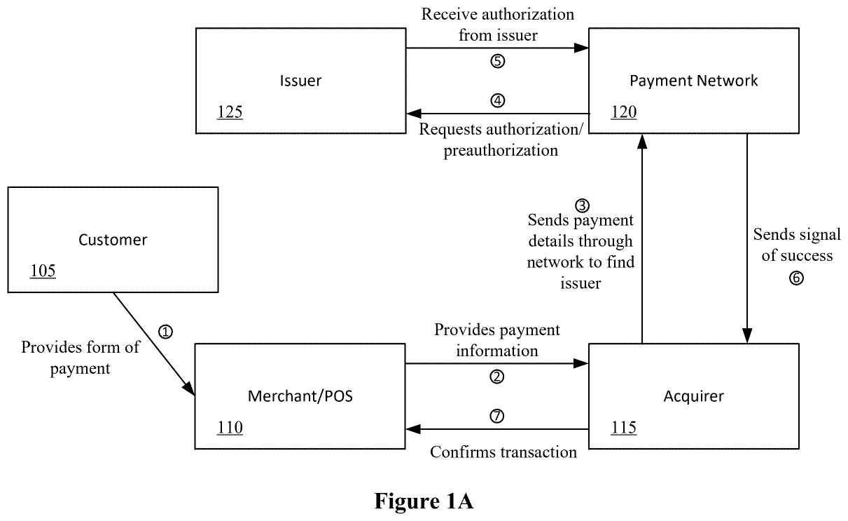

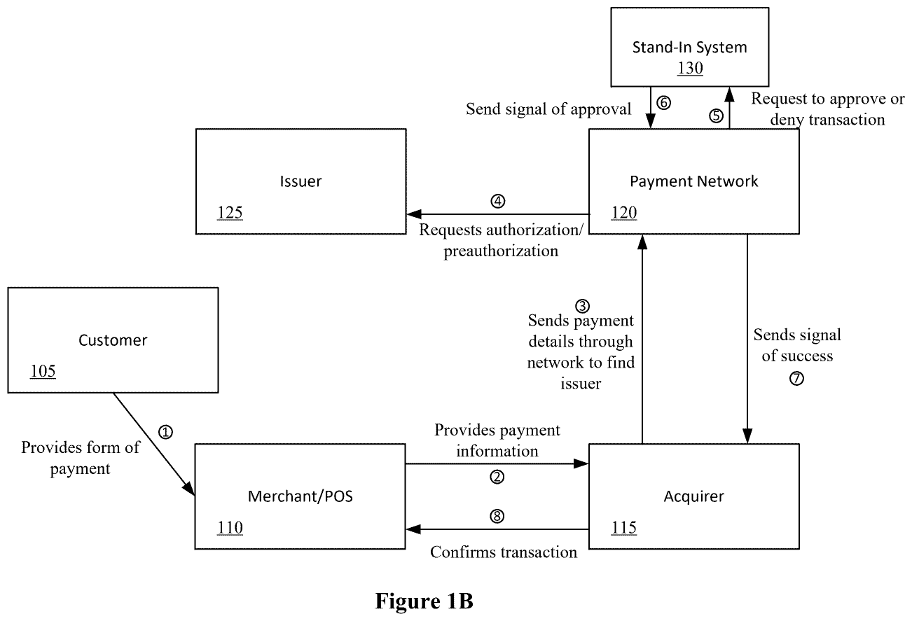

FIG. 1A illustrates an example conventional payment card process. Referring to FIG. 1A, in conventional payment card processes, there can be communication between a customer 105, merchant 110, an acquirer 115, a payment network 120, and an issuer 125. These communications can include a payment process using a payment card. The payment process can include payment card authorization, clearing, and settlement. The customer 105 can be the cardholder or a person authorized to use the account corresponding to the cardholder. The merchant 110 can be a provider of goods or services in exchange for payment. The merchant 110 can be physically present at a sale (e.g., as a point of sale terminal) or remote, such as an online retailer. The acquirer 115 can be a party that receives funds on behalf of the merchant 110 in a payment card transaction. The acquirer 115 can be a bank or other institution associated with the merchant 110. The payment network 120 facilitates transactions between merchants and payment card issuers. Examples of payment network 120 include the Mastercard payment network and the Visa payment network. An issuer 125 can be a bank or other institution that has an account associated with the customer and which issues the payment card to the customer.

A process of payment card authorization can begin with a customer 105 presenting a form of payment to purchase goods or services as shown in (1). When the form of payment is a physical card or a contactless card (e.g., hosted on a mobile device, and available on an e-wallet), a merchant 110 can receive the payment via a point-of-sale (POS) terminal to obtain information about the form of payment. The POS system can extract information about the form of payment such as the credit card number, confirmation code, and expiration date. Information obtained by the POS system can also include information about the purchase, such as location, amount, goods type, and a form of verification provided. This information may be stored in some form on merchant computing devices. A payment request, comprising at least the information about the form of payment and the information about the purchase, can be provided to an acquirer 115 associated with the merchant 110 as shown in (2). The acquirer 115 can, in turn, provide the payment request to the payment network 120 as shown in (3).

The payment network 120 can identify an issuing bank, or issuer 125, of the customer's form of payment. The transaction can be logged to aid in later processes, such as clearing and settlement. The details of the transaction can also be stored in a transaction details storage, which may be associated with the payment network 120. When the payment network 120 identifies the issuer 125, the payment network 120 can send the payment request and request, from the issuer 125, authorization and/or preauthorization on the form of payment, as shown in (4).

The issuer 125 can run the requested authorization or preauthorization. Authorization can entail ensuring that a transaction is legitimate, such as by checking the provided verification, location, and amount. For example, a provided form of verification can be compared against previously given verification (e.g. biometrics or signature) to determine if the customer is a legitimate user for the form of payment. Similarly, an issuer 125 can compare the location against typical spending locations to detect fraudulent charges. Finally, an issuer 125 can determine that a purchase is likely to be too high value to be legitimate and flag the purchase as possibly fraudulent. The authorization can also check to see if the card is currently locked or suspended. Pre-authorization can entail determining that a customer has sufficient credit or account balance to make the transaction. A credit card pre-authorization can be a temporary hold on funds equal to the payment that lasts for a period of time (e.g., 5 days). During the temporary hold, the funds cannot be used anywhere else, but the charge may not actually show up on the statement of the form of payment. After one or more of these checks are performed, the issuer 125 can accept the transaction and forward a payment result indicating success or failure back to the payment network 120 as shown in (5).

Once the payment result signal is received, the payment network 120 can forward the signal to the acquirer 115 as shown in (6). The acquirer can then forward the signal back to the merchant 110 as shown in (7) to confirm that the transaction has been authorized. Later on, settlement and clearing can occur. In clearing, the payment and transaction information can be double checked for accuracy. In settlement, the issuer 125 can transfer funds to the payment network 120; the payment network 120 can then transfer the funds to the acquirer 115. Once the acquirer 115 receives the funds, the funds can be made available to the merchant 110.

FIG. 1B illustrates an example payment card process with an authorization stand-in system. Referring to FIG. 1B, processes as shown in (1)-(4) can be performed as described with respect to FIG. 1A. However, unlike the conventional payment card process described with respect to FIG. 1A, in the process shown in FIG. 1B, the request of authorization/preauthorization to the issuer is not successful and the issuer 125 fails to send a signal indicating receipt of the request to the payment network 120 or fails to send payment result indicating success or failure back to the payment network 120. In some cases, the failure of the communication may be due to the issuer 125 experiencing difficulties (e.g., network outages, power outage, etc.). Based on the failure of the communication between the payment network 120 and the issuer 125, it is thus determined that the issuer is unavailable and cannot perform authorization and/or preauthorization.

When an issuer is registered with a stand-in application of a stand-in system 130 on the payment network 120, if, after the payment network 120 sends the request for authorization/preauthorization, as shown in flow (4), the issuer 125 fails to respond and/or there is an indication that the issuer 125 is unavailable, the payment network 120 can then direct a request to approve or deny the transaction to the stand-in system 130 in place of the authorization/preauthorization request, as shown in (5).

The stand-in system 130 can approve or deny the transaction on behalf of an issuer (e.g., issuer 125) when the issuer is unavailable. The stand-in system 130 is a backup or temporary system that performs transaction processing when the issuer 125 is unavailable or offline. In some cases, the stand-in system 130 is a system on the payment network 120.

The stand-in system 130 can determine whether to approve or deny the transaction by comparing a transaction amount to a transaction approval limit. In some cases, if the transaction amount is above the transaction approval limit, the stand-in system 130 denies the transaction. In some cases, if the transaction amount is at or below the transaction approval limit, the stand-in system 130 approves the transaction. Once the stand-in system 130 determines whether to approve or deny the transaction, the stand-in system 130 can accept the transaction and forward a payment result indicating success or failure back to the payment network 120 as shown in (6).

Once the payment result signal is received, the payment network 120 can forward the signal to the acquirer 115 as shown in (7). The acquirer can then forward the signal back to the merchant 110 as shown in (8) to confirm that the transaction has been authorized. Later on, settlement and clearing can occur as described with respect to FIG. 1A.

Conventionally, stand-in systems (e.g., stand-in system 130) have approval limits that set an upper limit for a transaction amount to control and prevent fraudulent transactions.

However, current stand-in systems may use inadequate limits that result in lower-than-desirable transaction approval rate while still permitting a relatively high volume of fraudulent transactions.

A transaction category code (TCC) recommendation feature is provided that can generate transaction approval limits that are based on transaction data and fraud rate with respect to transaction criteria to optimize for increased transaction approval and minimization of fraud rate.

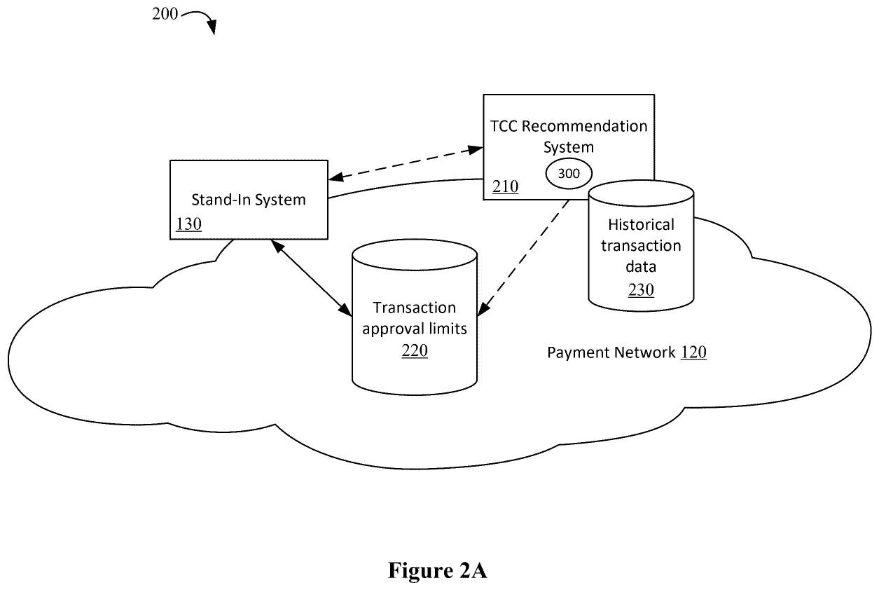

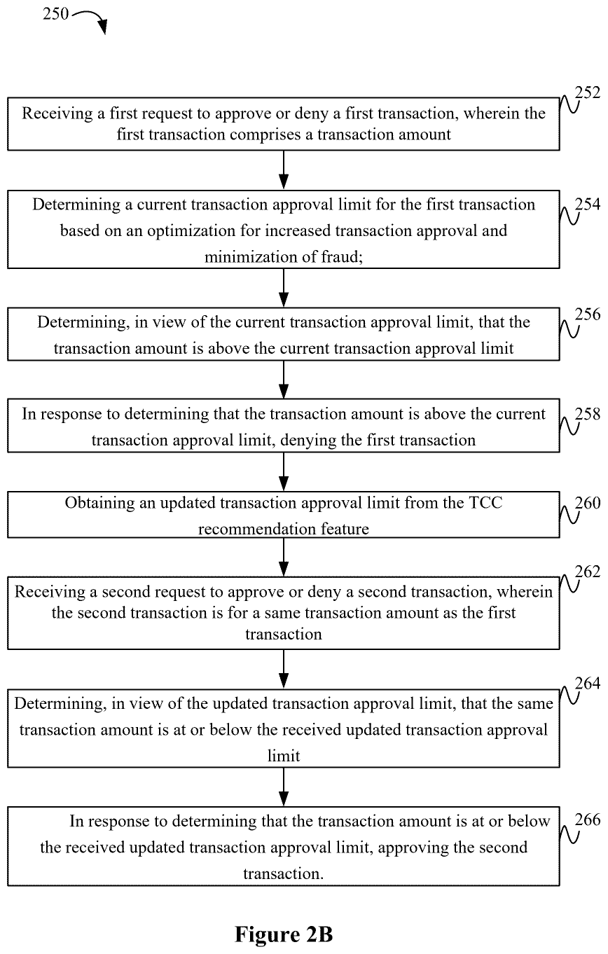

FIG. 2A illustrates an example operating environment for a TCC recommendation feature associated with a stand-in system on a payment network. Referring to FIG. 2A, operating environment 200 can include payment network 120, stand-in system 130, a TCC recommendation system 210, transaction approval limits resource 220, and historical transaction data resource 230. Payment network 120 and stand-in system 130 can perform the processes as described with respect to FIGS. 1A and 1B. The payment network 120 can include one or more computing systems, where the one or more computing systems can include one or more processing systems, one or more storage media, and instructions stored on the one or more storage media. The stand-in system 130 can include one or more processing systems, one or more storage media, and instructions stored on the one or more storage media. The TCC recommendation system 210 can include one or more processing systems, one or more storage media, and instructions stored on the one or more storage media. These computing systems can be the same or separate computing systems.

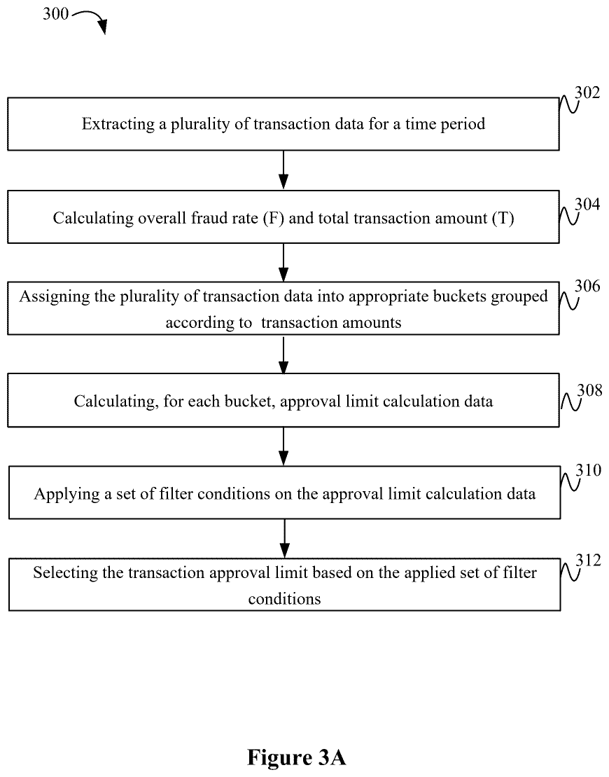

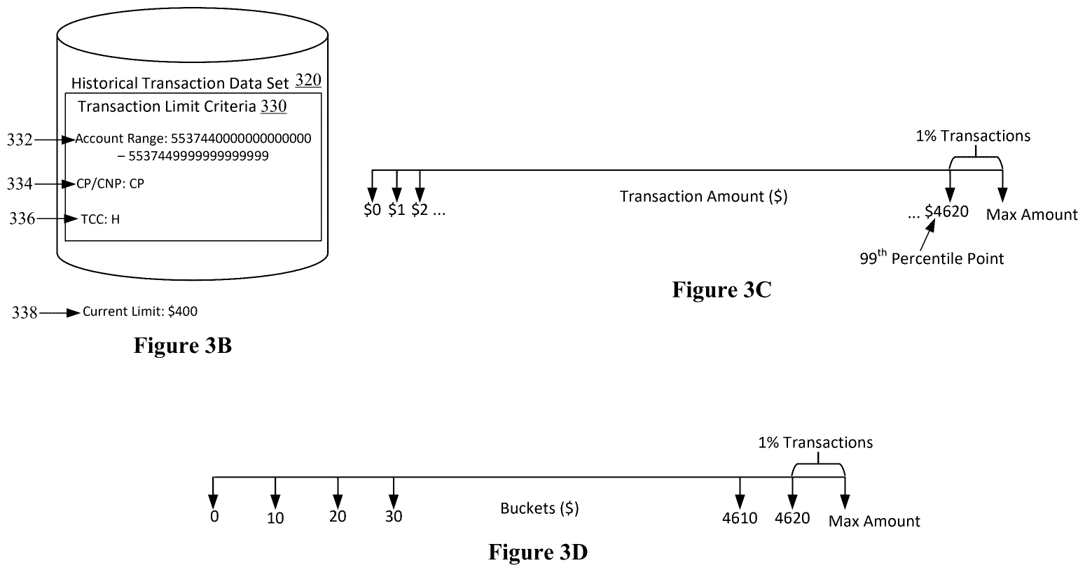

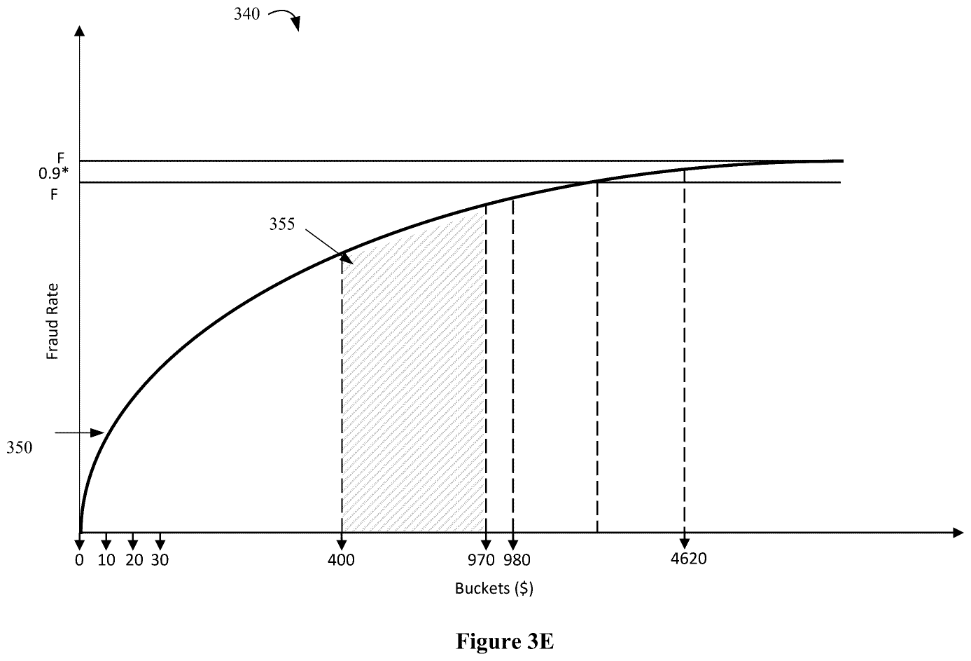

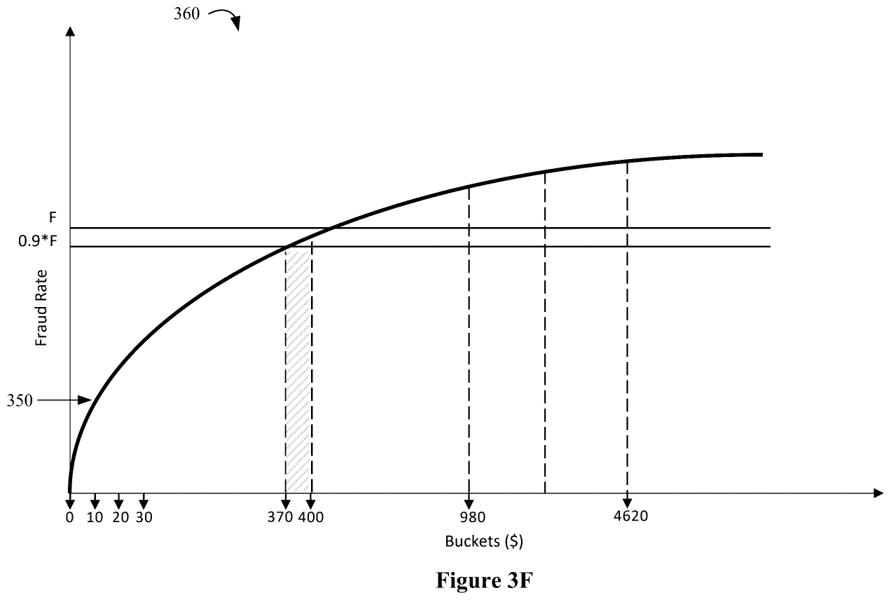

Advantageously, the stand-in system 130 can obtain transaction approval limits generated by the TCC recommendation system 210. The TCC recommendation system 210 provides a TCC recommendation feature for the stand-in system 130 that generates the transaction approval limits stored in the transaction approval limits resource 220 (e.g., via method 300 as described with respect to FIGS. 3A-3F). The TCC recommendation system 210 can be part of the same computing system as providing the stand-in system 130 or part of a different system on the payment network 120. When part of the stand-in system 130, operations of the TCC recommendation system 210 are performed by the stand-in system 130. In some cases, the TCC recommendation system 210 is a virtual computing system hosted on one or more systems associated with the payment network 120.

The TCC recommendation feature provided by the TCC recommendation system 210 generates transaction approval limits to increase transaction approval and minimize fraud rate. The TCC recommendation system 210 can access a historical transaction data resource 230 to obtain historical transaction data. The historical transaction data can be used to generate the transaction approval limits. For example, the TCC recommendation system 210 can periodically update values of the transaction approval limits (e.g., monthly, biannually, annually, etc.) based on updates to the historical transaction data over time. In some cases, the TCC recommendation system 210 provides the generated transaction approval limits to the transaction approval limits resource 220 for access by the stand-in system 130. In some cases, the TCC recommendation system 210 provides the generated transaction approval limits to the stand-in system 130 so that the stand-in system 130 can update the transaction approval limits resource 220 used by the stand-in system 130.

In this manner, when the stand-in system 130 is in use (e.g., such as described by FIG. 1B), a transaction amount may be approved (or denied) at one point in time and, after an update by the TCC recommendation feature, that same transaction amount is denied (or approved if previously denied).

FIG. 2B illustrates an example method at a stand-in system with a transaction category code (TCC) recommendation feature. Referring to FIGS. 2A-2B, method 250 of operating a stand-in system 130 on a payment network 120 includes receiving (252) a first request to approve or deny a first transaction, wherein the first transaction comprises a transaction amount; determining (254) a current transaction approval limit for the first transaction based on an optimization for increased transaction approval and minimization of fraud; determining (256), in view of a current transaction approval limit, that the transaction amount is above the current transaction approval limit; and in response to determining (256) that the transaction amount is above the current transaction approval limit, denying (258) the first transaction.

Then, after a predetermined period of time or as a result of some trigger, the method 250 can further include obtaining (260) an updated transaction approval limit from a TCC recommendation feature associated with the stand-in system 130 on the payment network 120. The TCC recommendation feature can adjusts the current transaction approval limit based on transaction data and fraud rate with respect to transaction criteria, where the updated transaction approval limit being generated to optimize for increased transaction approval and minimization of fraud rate. The method 250 can thus continue by receiving (262), at the stand-in system 130, a second request to approve or deny a second transaction, wherein the second transaction is for a same transaction amount as the first transaction amount; determining (264), in view of the updated transaction approval limit, that the same transaction amount is at or below the received updated transaction approval limit; and in response to determining (264) that the transaction amount is at or below the received updated transaction approval limit, approving (266) the second transaction.

FIG. 3A illustrates an example method of generating a transaction approval limit. FIGS. 3B-3F provide an illustrative example of the method of generating a transaction approval limit of FIG. 3A. Method 300 can be embodied as instructions for a TCC recommendation feature executed by a computing system (e.g., TCC recommendation system 210 of FIG. 2A).

Referring to FIGS. 3A-3F, method 300 can begin by extracting (302) a plurality of transaction data for a time period.

Extracting (302) a plurality of transaction data for a time period can include extracting data that includes data belonging to a particular account range and satisfying a set of criteria. For example, historical transaction data set 320 can be extracted from a larger set of data. The data included in the historical transaction data set 320 satisfies the transaction limit criteria 330. The transaction limit criteria 330 can include an account range 332, a card-present (CP)/card-not-present (CNP) indicator 334, and a transaction category code (TCC) 336. For the data satisfying the transaction limit criteria 330, a current limit 338 used by a stand-in system can also be retrieved. In the illustrative example shown in FIG. 3B, the account range 332 is 5537440000000000000-5537449999999999999, the CP/CNP indicator 334 is CP, the TCC 336 is H (indicating “hotel”), and the current limit 338 is $400.

The account range 332 indicates a range of account numbers. The CP/CNP indicator 334 indicates whether the transaction is a card-present or card-not-present transaction. The TCC 336 indicates a category of transaction (e.g., hotel, restaurant, flight, etc.).

Next, method 300 includes calculating (304) an overall fraud rate (F) and total transaction amount (T). The overall fraud rate (F) is calculated as total fraud amount/total approved amount. Total transaction amount (T) is calculated by adding the transaction amounts for each transaction in the historical transaction data set 320. The values of total fraud amount and total approved amount are found in the historical transaction data set 320.

Calculating (304) the overall fraud rate and total transaction amount can include removing outliers before performing the calculations such as adding the transaction amounts to generate the total transaction amount. For example, the transaction data (e.g., of historical transaction data set 320) can first be sorted by transaction amount ($) into increasing order. Then, the top certain percentage of transactions are discarded. In some cases, the 99^{th} percentile point/top 1 percentile point is identified and used to remove outliers. FIG. 3C illustrates a line graph of the transaction data points of historical transaction data set 320 (which were extracted as belonging to account range +CP/CNP+TCC for the past 6 months) sorted by transaction amount ($) (e.g., $0, $1, $2 . . . $4620). The 99th percentile point is the particular dollar amount that consists of 99% of transactions. In some cases, the transaction dollar amount is rounded into integer amounts (e.g., $0, $1, $2 . . . $4620). In some cases, the transaction dollar amount includes decimals (e.g., $0, $0.50, $1, etc.) However, it can be advantageous to use integer amounts because the more granular the data is, the more computational resources are required.

Method 300 further includes assigning (306) the plurality of transaction data into appropriate buckets grouped according to transaction amounts. A bucket is a parameter representing a range of transaction values such that transactions that fall within a specified range of transaction values are grouped together and assigned the same transaction value. Assigning (306) the plurality of transaction data into appropriate buckets can include dividing the data (e.g., data of historical transaction data set 320 after removing the outliers) into groups and giving those data in the same group the same transaction value. As shown in Table 1, the data of the historical transaction data set 320 is assigned based on falling within a specified range to buckets representing discrete $10 increments. In other words, each transaction can be allocated into a bucket corresponding to a multiple of $10. For example, in the case of transaction ID 1, which has a transaction amount of $23, it is put in the 30 bucket because it has a transaction amount that falls between $21-$30. As a result, there is a discrete set of values up to a maximum amount.

TABLE 1

| Transaction ID | Transaction Amount | Bucket |
|---|---|---|
| 1 | $23 | 30 |
| 2 | $17 | 20 |
| 3 | $20 | 20 |
| 4 | $30 | 30 |

Method 300 further includes calculating (308), for each bucket, approval limit calculation data. Approval limit calculation data can include a transaction count, a transaction amount, an approval count, an approval amount, a fraud count, a fraud amount, an overall transaction amount, a transaction percentage, a cumulative approval amount, a cumulative fraud amount, and a fraud rate.

For example, as shown in Tables 2-4 a transaction amount, an approval count, an approval amount, a fraud count, a fraud amount, an overall transaction amount, a transaction percentage, a cumulative approval amount, a cumulative fraud amount, and a fraud rate have been calculated for each bucket shown (e.g., 10, 20, 30, etc.).

Table 2 illustrates, for each bucket, a transaction (“txn”) count, a transaction amount (in dollars), an approval (“app”) count, an approval amount (in dollars), a fraud count, a fraud amount (in dollars), and an overall transaction amount (in dollars). A transaction count indicates the number of transactions that occurred for a specific bucket, for example, as shown in Table 2, for the 10 bucket, there are 1000 transactions that have a value between $0-$10. The transaction amount ($) indicates the total aggregate dollar amount of the 1000 transactions, for example, for the 10 bucket, the transaction amount is $6448. The approval count indicates the total number of transactions that were approved out of the total transactions represented by the transaction count. For example, for the 10 bucket, 859 transactions (e.g., indicated by approval count) out of the 1000 transactions (e.g., indicated by transaction count) were approved. The approval amount ($) indicates the total aggregate dollar amount of the approved transactions, for example, for the 10 bucket, the approval amount is $5223. The fraud count indicates, out of the total approved transactions (e.g., indicated by approval count), how many transactions contained fraud, for example, for the 10 bucket, out of the 859 approved transactions, 42 were fraudulent. The fraud amount indicates the total aggregate dollar amount of the fraudulent transactions, for example, for the 10 bucket, the fraud amount ($) is $600. The overall transaction amount ($) indicates the total aggregate dollar amount of the transaction amount ($).

TABLE 2

| | | | | | | | Overall |
|---|---|---|---|---|---|---|---|
| | | Txn | | App | | Fraud | Txn |
| | Txn | Amount | App | amount | Fraud | amount | amount |
| Bucket | Count | ($) | count | ($) | count | ($) | ($) |
| 0 | 0 | 0 | 0 | 0 | 0 | 0 | 23933579 |
| 10 | 1000 | 6448 | 859 | 5223 | 42 | 600 | 23933579 |
| 20 | 600 | 8112 | 420 | 7652 | 30 | 778 | 23933579 |
| 30 | 300 | 10610 | 270 | 6241 | 18 | 850 | 23933579 |

Table 3 illustrates the calculation of the transaction percentage share of each bucket in terms of amounts. The transaction percentage=transaction amount ($) (t)/overall transaction amount ($) (T). The transaction percentage shows the distribution of data within each bucket.

TABLE 3

| | | | | | | | Overall | |
|---|---|---|---|---|---|---|---|---|
| | | Txn | | App | | Fraud | Txn | Txn |
| | Txn | Amount | App | amount | Fraud | amount | amount | perc |
| Bucket | Count | ($) (t) | count | ($) | count | ($) | ($) (T) | (t/T) |
| 0 | 0 | 0 | 0 | 0 | 0 | 0 | 23933579 | 0% |
| 10 | 1000 | 6448 | 859 | 5223 | 42 | 600 | 23933579 | 0.03% |
| 20 | 600 | 8112 | 420 | 7652 | 30 | 778 | 23933579 | 0.03% |
| 30 | 300 | 10610 | 270 | 6241 | 18 | 850 | 23933579 | 0.04% |
| 980 | 0 | 0 | 0 | 0 | 0 | 0 | 23933579 | 0% |

Table 4 illustrates a calculated cumulative approval amount ($), the cumulative fraud amount ($), and fraud rate for all buckets shown. The cumulative approval amount is the aggregate of the approval amount for each particular bucket plus the approval amount for the preceding buckets. For example, the cumulative approval amount for bucket 10 includes approval amount for 0 bucket and 10 bucket, resulting in a cumulative approval amount that is the same as the approval amount as shown in Table 3 (e.g., $5223). For bucket 20, because the cumulative approval amount includes the approval amount for each bucket preceding bucket 20 (e.g., 0 bucket and 10 bucket) and including 20 bucket, the cumulative approval amount is $12885 (e.g., 10 bucket approval amount+20 bucket approval amount as shown in Table 3).

Cumulative fraud amount is the aggregate of the fraud amount for each bucket and all preceding buckets. For example, cumulative fraud amount for 30 bucket is $2228, which is the aggregate fraud amount of 0 bucket ($0), 10 bucket ($600), 20 bucket ($778), and 30 bucket ($850). Fraud rate is calculated as cumulative fraud amount/cumulative approval amount. For example, the fraud rate for bucket 10 is 0.015-600/5223. Fraud rate is distinct from the overall fraud rate (F), which is calculated by total fraud amount/total approved amount (e.g., for all transactions the transaction data set).

TABLE 4

| | App | Fraud | Txn | Cumulative | Cumulative | |
|---|---|---|---|---|---|---|
| | amount | amount | perc | app amount | fraud amount | Fraud |
| Bucket | ($) | ($) | (t/T) | ($) | ($) | Rate |
| 0 | 0 | 0 | 0% | 0 | NA | NA |
| 10 | 5223 | 600 | 0.03% | 5223 | 600 | 0.015 |
| 20 | 7652 | 778 | 0.03% | 12875 | 1378 | 0.106 |
| 30 | 6241 | 850 | 0.04% | 19116 | 2228 | 0.116 |

Next, after calculating (308) for each bucket, approval limit calculation data, method 300 includes applying (310) a set of filter conditions on the approval limit calculation data, and selecting (312) a transaction limit based on the applied set of filter conditions.

For example, FIGS. 3E-3F illustrate graphs displaying filter conditions applied to approval limit calculation data. Both graph 340 of FIG. 3E and graph and graph 360 of FIG. 3F show transaction level data split into $10 increments (e.g., buckets) on the X-axis (e.g., line graph of buckets illustrated in FIG. 3D) and fraud rate on the Y-axis. The line shows cumulative fraud rate 350. As shown by cumulative fraud rate 350, the cumulative fraud rate amounts for each bucket are plotted. F indicates overall fraud rate (F=total fraud amount/total approved transaction amount).

In some cases, as shown in FIG. 3E, applying (310) a set of filter conditions on the approval limit calculation data can include a filter to filter out buckets that are greater than the current limit 338 (e.g., $400). The set of filter conditions can also include a filter to filter for buckets that are less than equal to the 99-percentile value (e.g., 4620) (e.g., as described with respect to FIG. 3C). In other words, the filter removes the top 1 percentile values in terms of dollar amount. By applying this filter, anomalies that may be present in the data are removed. The set of filter conditions can also include a filter to filter for buckets having a fraud rate is less than or equal to the 0.9*F, where F is overall fraud rate. Advantageously, 0.9*F is used (as opposed to F) to avoid going into extreme values. For example, if historically, there is not a large volume of fraud happening in higher buckets (e.g., higher values), the limit could be exponentially increased on that basis. However, these are extreme/fringe cases, and raising the limit based on those exceptions would result in a limit that was too high and ultimately would result in more fraud. Other limits may be selected (e.g., 0.5*F, 1.5*F, 2*F etc.) depending on various situations.

The filter conditions may also include a filter for buckets having a transaction percentage that is greater than or equal to 0.01%. For example, as shown in Table 3, there are no transactions that fall into the 980 bucket (e.g., transaction percentage is 0%). Therefore, even though bucket 980 satisfies the other filter conditions, it will not be used as the recommended limit because the transaction percentage is less than 0.01%.

The buckets that are left after applying these filters are shown by the shaded region 355 (e.g., bucket 410-bucket 970). In some cases, selecting (312) the transaction approval limit based on the applied set of filter conditions includes selecting, as the limit, the value corresponding to the largest bucket that satisfies all of the filtered conditions. In this case, as shown in graph 340, a new limit of $970 can be recommended. Specifically, the limit of $970 is the limit for transactions that have the same characteristics as the transaction limit criteria 330, as described with respect to FIG. 3D. For example, for card present transactions at hotels for accounts within the range of 5537440000000000000-5537449999999999999, the recommended new limit is $970.

In some cases, such as shown in FIG. 3F, applying (310) a set of filter conditions on the approval limit calculation data can include a filter to filter out buckets that are less than or equal to the current limit 338 (e.g., $400). That is, the set of filter conditions can include a second filter selecting for a determined second bucket that is below the current transaction approval limit. In some cases, it may be advantageous to select a limit that is less than or equal to the current limit 338 (e.g., fraud rate too high for current or higher limits). In this case, the set of filter conditions can also include a filter for buckets where the cumulative transaction amount is greater than or equal to 0.98*cumulative transaction amount at the current limit. Filtering for cumulative transaction amount that is greater than or equal to 0.98*cumulative transaction amount ensures that the recommended decreased limit is not more than 2% drop in transaction volume. If an intersection point on graph 360 is determined based on the first set of filters, the process can be stopped. If no intersection point is determined with the first set of filters, then, certain conditions can be checked in sequential order. For example, first, taking the biggest bucket that satisfies the condition of having a fraud rate that is less than or equal to 0.9*overall fraud rate. Second, identify the bucket with fraud rate lower than current limit (e.g., a fraud rate lower than the fraud rate for the current limit 338 ($400)). If no bucket satisfies these conditions, no recommendation is made and the current limit can be kept.

Advantageously, by performing method 300, the described TCC recommendation feature can generate a transaction approval limit that is based on transaction data and fraud rate with respect to transaction criteria to optimize for increased transaction approval and minimization of fraud rate.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
receiving, at a stand-in system with a transaction category code (TCC) recommendation feature on a payment network, a first request to approve or deny a first transaction, wherein the first transaction comprises a transaction amount;
determining, at the stand-in system, a current transaction approval limit for the first transaction based on an optimization for increased transaction approval and minimization of fraud;
determining, at the stand-in system, in view of the current transaction approval limit, that the transaction amount is above the current transaction approval limit;
in response to determining that the transaction amount is above the current transaction approval limit, denying the first transaction;
obtaining, by the stand-in system, an updated transaction approval limit from the TCC recommendation feature, wherein the TCC recommendation feature adjusts the current transaction approval limit based on transaction data and fraud rate with respect to transaction criteria, wherein the updated transaction approval limit is generated to optimize for the increased transaction approval and minimization of fraud rate;
receiving, at the stand-in system, a second request to approve or deny a second transaction, wherein the second transaction is for a same transaction amount as the first transaction;
determining, at the stand-in system, in view of the updated transaction approval limit that the same transaction amount is at or below the received updated transaction approval limit; and
in response to determining that the transaction amount is at or below the received updated transaction approval limit, approving the second transaction.

2. The method of claim 1, wherein the stand-in system obtains the updated transaction approval limit from the TCC recommendation feature after a predetermined period of time.

3. The method of claim 1, wherein the stand-in system obtains the updated transaction approval limit from the TCC recommendation feature based on a trigger.

4. The method of claim 1, wherein the TCC recommendation feature adjusts the current transaction approval limit by:
extracting a plurality of transaction data for a time period, wherein the plurality of transaction data comprises data belonging to a particular account range and satisfying a set of criteria;
calculating overall fraud rate (F) and total transaction amount (T);
assigning the plurality of transaction data to appropriate buckets grouped according to transaction amounts;
calculating, for each bucket, approval limit calculation data, wherein approval limit calculation data comprises a transaction count, a transaction amount, an approval count, an approval amount, a fraud count, a fraud amount, an overall transaction amount, a transaction percentage, a cumulative approval amount, a cumulative fraud amount, and a fraud rate;
applying a set of filter conditions on the approval limit calculation data, wherein the set of filter conditions comprises a filter selecting for a determined first bucket that is above the current transaction approval limit; and
selecting updated transaction approval limit based on the applied set of filter conditions.

5. A computer-readable storage medium having instructions stored thereon for transaction category code (TCC) recommendation feature that when executed by a computing system direct the computing system to:
generate a transaction approval limit that is based on transaction data and fraud rate with respect to transaction criteria to optimize for increased transaction approval and minimization of fraud rate by:
extracting a plurality of transaction data for a time period, wherein the plurality of transaction data comprises data belonging to a particular account range and satisfying a set of criteria;
calculating overall fraud rate (F) and total transaction amount (T);
assigning the plurality of transaction data to appropriate buckets grouped according to transaction amounts;
calculating, for each bucket, approval limit calculation data, wherein approval limit calculation data comprises a transaction count, a transaction amount, an approval count, an approval amount, a fraud count, a fraud amount, an overall transaction amount, a transaction percentage, a cumulative approval amount, a cumulative fraud amount, and a fraud rate;
applying a set of filter conditions on the approval limit calculation data, wherein the set of filter conditions comprises a filter selecting for a determined first bucket that is above a current transaction approval limit; and
selecting the transaction approval limit based on the applied set of filter conditions.

6. The computer-readable storage medium of claim 5, wherein the set of filter conditions further comprises a second filter selecting for a determined second bucket that is below the current transaction approval limit.

7. The computer-readable storage medium of claim 5, wherein the plurality of transaction data for a time period comprises a total fraud amount and a total approved amount, and wherein calculating overall fraud rate (F) is given as F=total fraud amount/total approved amount.

8. The computer-readable storage medium of claim 5, wherein the plurality of transaction data for a time period comprises a plurality of transactions, and a plurality of transaction amounts associated with each of the plurality of transactions, and wherein calculating the total transaction amount (T) comprises a summation of the plurality of transaction amounts.

9. The computer-readable storage medium of claim 5, wherein a bucket is a parameter representing a range of transaction values, wherein each transaction of the plurality of transaction data that falls within a specified range of transaction values are grouped together and assigned a same transaction value.

10. The computer-readable storage medium of claim 5, wherein the buckets represent discrete increments.

11. The computer-readable storage medium of claim 5, wherein the set of filter conditions comprises a filter to filter out buckets that are greater than the current limit.

12. The computer-readable storage medium of claim 5, wherein the set of filter conditions comprises a filter to filter for buckets having a fraud rate less than or equal to 0.9*F.

13. The computer-readable storage medium of claim 5, wherein selecting the transaction approval limit comprises selecting a limit that is less than or equal to a current transaction approval limit.

14. A payment network, comprising:
a system, wherein the system comprises:
a first processing system;
one or more first storage media; and
first instructions stored on the one or more first storage media that, when executed by the first processing system, direct the system to:
receive a preauthorization request for a transaction;
determine that an issuer is unavailable; and
based on the determination that the issuer is unavailable, direct a first request to approve or deny the transaction in place of the preauthorization request to a stand-in system; and
a stand-in system, wherein the stand-in system comprises:
a second processing system;
one or more second storage media; and
second instructions stored on the one or more second storage media that, when executed by the second processing system, direct the stand-in system to:
receive the first request to approve or deny the transaction; and
determine an approval or denial of the transaction based on a transaction approval limit that is based on transaction data and fraud rate with respect to transaction criteria to optimize for increased transaction approval and minimization of fraud rate, wherein the stand-in system comprises a transaction category code (TCC) recommendation feature that adjusts the transaction approval limit.

15. The payment network of claim 14, wherein the second instructions further direct the stand-in system to obtain an updated transaction approval limit from the TCC recommendation feature after a predetermined period of time.

16. The payment network of claim 14, wherein the second instructions further direct the stand-in system to obtain an updated transaction approval limit from the TCC recommendation feature based on a trigger.

17. The payment network of claim 14, further comprising:
a third processing system;
one or more third storage media; and
third instructions of the TCC recommendation feature stored on the one or more third storage media that, when executed by the third processing system, direct the third processing system to:
generate the transaction approval limit that is based on transaction data and fraud rate with respect to transaction criteria to optimize for increased transaction approval and minimization of fraud rate, wherein the third instructions to generate the transaction approval limit direct the third processing system to:
extract a plurality of transaction data for a time period, wherein the plurality of transaction data comprises data belonging to a particular account range and satisfying a set of criteria;
calculate overall fraud rate (F) and total transaction amount (T);
assign the plurality of transaction data to appropriate buckets grouped according to transaction amounts;
calculate, for each bucket, approval limit calculation data, wherein approval limit calculation data comprises a transaction count, a transaction amount, an approval count, an approval amount, a fraud count, a fraud amount, an overall transaction amount, a transaction percentage, a cumulative approval amount, a cumulative fraud amount, and a fraud rate;
apply a set of filter conditions on the approval limit calculation data, wherein the set of filter conditions comprises a filter selecting for a determined first bucket that is above a current transaction approval limit; and
select the transaction approval limit based on the applied set of filter conditions.

18. The payment network of claim 17, wherein the set of filter conditions further comprises a second filter selecting for a determined second bucket that is below the current transaction approval limit.

19. The payment network of claim 17, wherein the set of filter conditions comprises a filter to filter for buckets having a fraud rate less than or equal to 0.9*F.

20. The payment network of claim 17, wherein the plurality of transaction data for a time period comprises a total fraud amount and a total approved amount, and wherein the third instructions to calculate overall fraud rate (F) are given as F=total fraud amount/total approved amount.
